(19) United States
(12) Patent Application Publication
(10) Pub. No.: US 2013/0233176 A1
(43) Pub. Date: Sep. 12, 2013

(54) Coffee Maker Capable of Stopping Returning Steam

(71) Applicant: Yu-Yuan Lin, Tainan (TW)

(72) Inventor: Yu-Yuan Lin, Tainan (TW)

(21) Appl. No.: 13/415,900

(22) Filed: Mar. 9, 2012

(51) Int. Cl. A47J 31/42

(52) U.S. Cl. 99/286

(57) ABSTRACT

A coffee maker capable of stopping returning steam includes a grinding unit, a guiding unit, and a brewing unit. A conduit extends laterally from a container disposed at a lower portion of the grinding unit and adapted to hold the coffee particles. The conduit has an outlet corresponding in position to an opening formed on a cover portion at a top of the brewing unit. A decelerating motor is disposed at the cover portion. An axle of the decelerating motor is coupled to a lid. When the coffee particles exit the grinding unit and enter the brewing unit via the conduit to accumulate in the brewing unit to a preset quantity level, the decelerating motor drives the lid to shut the opening. Hence, high-temperature steam introduced into the brewing unit for brewing coffee is prevented from entering the grinding unit to wet the residual coffee particles therein.

### BACKGROUND OF THE INVENTION

1. Field of the Invention

The present invention relates to coffee makers capable of stopping returning steam, and more particularly, to a coffee maker capable of stopping returning steam in a manner that an outlet adapted to let in coffee particles is shut as soon as high-temperature steam is introduced into a brewing unit, so as to prevent the high-temperature steam from entering a grinding unit to wet residual coffee particles therein.

2. Description of Related Art

Conventional coffee makers come in a wide variety of forms and usually each comprise a grinding unit for grinding coffee beans into coffee particles, a guiding unit for discharging the coffee particles, and a brewing unit for brewing coffee from the coffee particles delivered thereto at high temperature. An outlet formed at one end of the guiding unit and adapted to let the coffee particles enter the brewing unit is usually open. As a result, high-temperature steam introduced into the brewing unit is likely to enter the grinding unit via the guiding unit to wet the residual coffee particles in the grinding unit.

### SUMMARY OF THE INVENTION

The present invention is aimed at overcoming a drawback of a conventional coffee maker, that is, high-temperature steam is likely to enter a grinding unit via a guiding unit to wet residual coffee particles in the grinding unit. A decelerating motor at the upper end of a brewing unit of the coffee maker drives a lid to move to shut or open an outlet formed at one end of the guiding unit in a manner that the outlet adapted to let in the coffee particles is shut as soon as high-temperature steam is introduced into a brewing unit, so as to prevent the high-temperature steam from entering the grinding unit to wet residual coffee particles therein.

It is an objective of the present invention to provide a coffee maker that comprises a grinding unit for grinding coffee beans into coffee particles, a guiding unit for discharging the coffee particles, and a brewing unit for brewing coffee from the coffee particles delivered thereto at high temperature. A conduit extends laterally from a container disposed at the lower portion of the grinding unit and adapted to hold the coffee particles, and the conduit has an outlet corresponding in position to an opening formed on a cover portion at the top of the brewing unit. A decelerating motor is disposed at a preset position of the cover portion at the top of the brewing unit, and an axle of the decelerating motor is coupled to a lid. An axle of the decelerating motor is coupled to a lid. When the coffee particles exit the grinding unit and enter the brewing unit via the conduit to accumulate in the brewing unit to a preset quantity level, the decelerating motor drives the lid to undergo a displacement and thereby shut the opening at the top of the brewing unit, such that high-temperature steam introduced into the brewing unit for brewing coffee from the coffee particles is prevented from entering the grinding unit via the conduit to wet the residual coffee particles in the grinding unit.

Another objective of the present invention is to provide a silicone plug tightly embedded in the bottom of the lid coupled to the axle of the decelerating motor disposed at the cover portion at the top of the brewing unit. The silicone plug is effective in shutting the opening of the cover portion tightly, because the silicone plug undergoes thermal expansion when confronted with the high-temperature steam introduced into the brewing unit for making coffee from the coffee particles and thereby operates in conjunction with the lid in providing better hermetic seal.

### BRIEF DESCRIPTION OF THE SEVERAL VIEWS OF THE DRAWINGS

FIG. 1 is an exploded view of a coffee maker capable of stopping returning steam according to the present invention;

FIG. 2 is a perspective view of the coffee maker capable of stopping returning steam according to the present invention;

FIG. 3 is a cutaway view of the coffee maker capable of stopping returning steam according to the present invention;

FIG. 4 is a top view of the coffee maker with a lid opened by a mechanism for stopping returning steam according to the present invention;

FIG. 5 is a schematic view of the coffee maker with coffee beans therein according to the present invention;

FIG. 6 is a top view of the coffee maker with the lid shut by the mechanism for stopping returning steam according to the present invention;

FIG. 7 is a cutaway view of the coffee maker with the lid shut by the mechanism for stopping returning steam according to the present invention; and

FIG. 8 is a schematic view of the coffee maker with high-temperature steam being delivered thereto according to the present invention.

### DETAILED DESCRIPTION OF THE EMBODIMENTS OF THE INVENTION

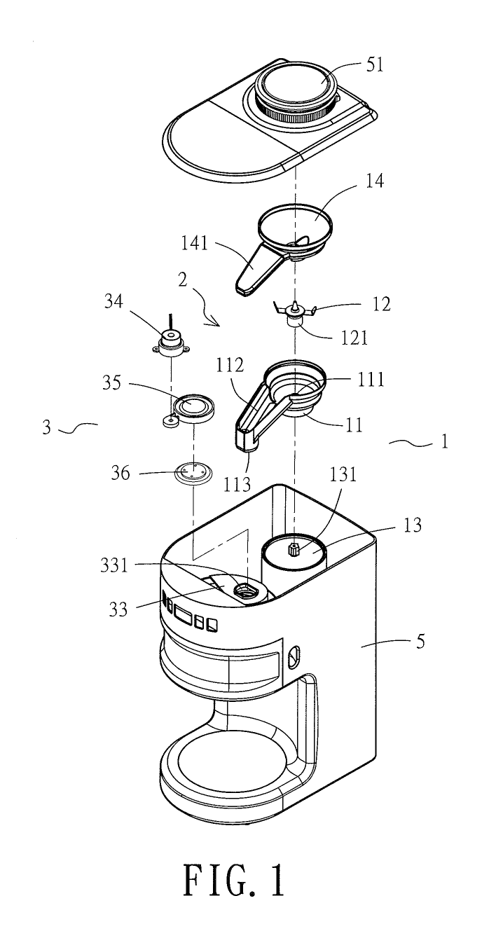

Referring to FIG. 1, the present invention provides a coffee maker 5 capable of stopping returning steam. The coffee maker 5 comprises a grinding unit 1 for grinding coffee beans into coffee particles, a guiding unit 2 for discharging the coffee particles, and a brewing unit 3 for brewing coffee from the coffee particles delivered thereto at high temperature.

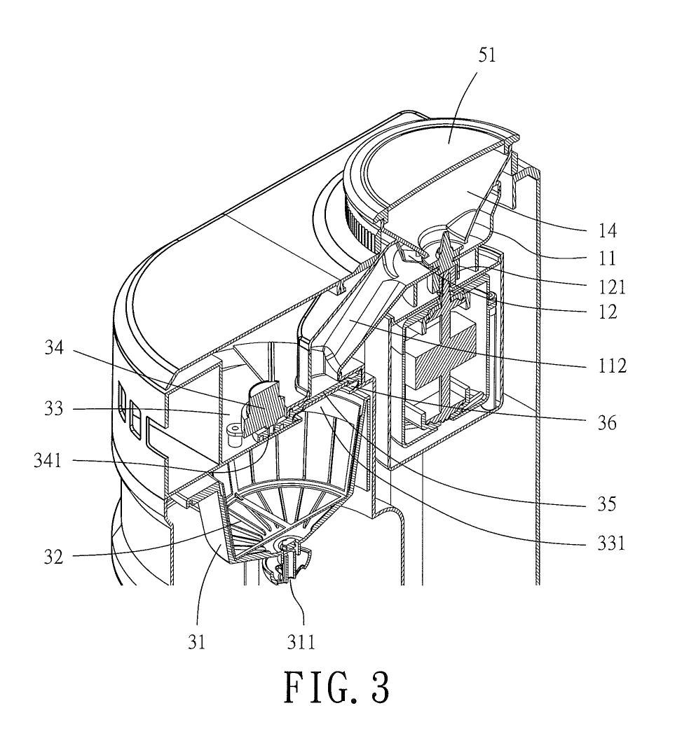

The grinding unit 1 is disposed at one end of the coffee maker 5 for grinding coffee beans. The grinding unit 1 comprises a container 11 for holding the coffee beans to be grounded. Disposed at the center of the container 11 is a hole 111 for allowing a blade 12 to rest on the container 11 and allowing a downward-extending tube 121 of the blade 12 to penetrate the hole 111 and be pivotally coupled to the hole 111 of the container 11 (as shown in FIG. 3.) The tube 121 of the blade 12 is coupled to an axle 131 of a driving motor 13 disposed in the coffee maker 5. A funnel 14 is disposed on the container 11 and adapted to hold the coffee beans to be grounded. A cover portion 141 extends laterally and obliquely downward from the funnel 14.

The guiding unit 2 discharges the coffee particles into the brewing unit 3. In an embodiment, the guiding unit 2 is implemented in the form of a backward-tapering U-shaped conduit 112 extending laterally and obliquely downward from the container 11 of the grinding unit 1. The cover portion 141 extending laterally from the funnel 14 covers and rests on the conduit 112 to form a tubular structure (as shown in FIG. 3) and form an outlet 113 at the terminal end of the conduit 112.

The brewing unit 3 brews coffee from the coffee particles delivered thereto. The brewing unit 3 comprises a container 31 provided at a lower end thereof with a control outlet 311 and provided therein with a filtering chamber 32 (as shown in FIG. 3.) A cover portion 33 (shown in FIG. 1) is formed at the top of the brewing unit 3. Formed at a preset position of the cover portion 33 is an opening 331. The outlet 113 at the terminal end of the conduit 112 corresponds in position to the opening 331. A decelerating motor 34 is disposed at a preset position of the cover portion 33. An axle 341 of the decelerating motor 34 is coupled to a lid 35. An integrated circuit (IC) of the decelerating motor 34 controllably drives the lid 35 to undergo a preset angular displacement so as to shut or open the opening 331 of the cover portion 33. The bottom of the lid 35 has a recess that tapers upward to receive a silicone plug 36 (as shown in FIGS. 1, 3.)

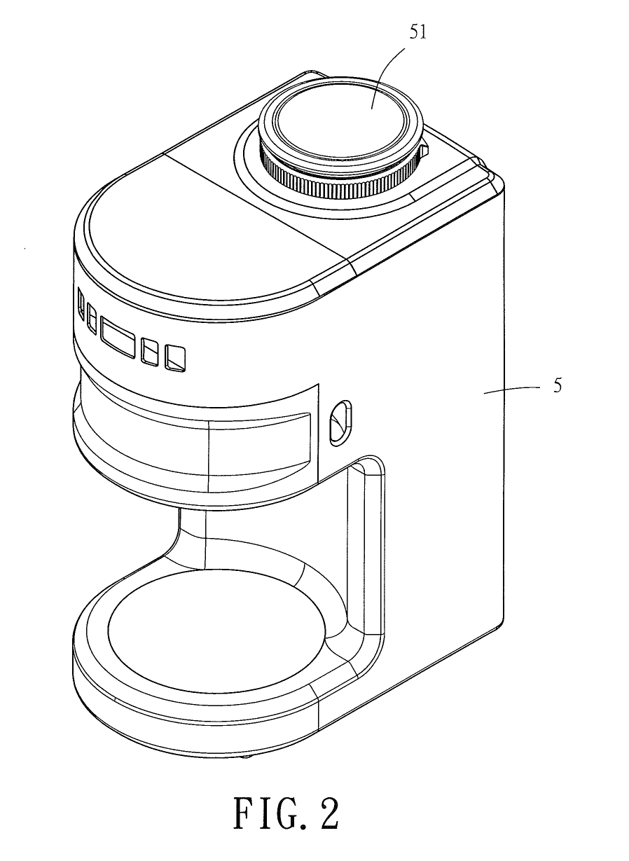

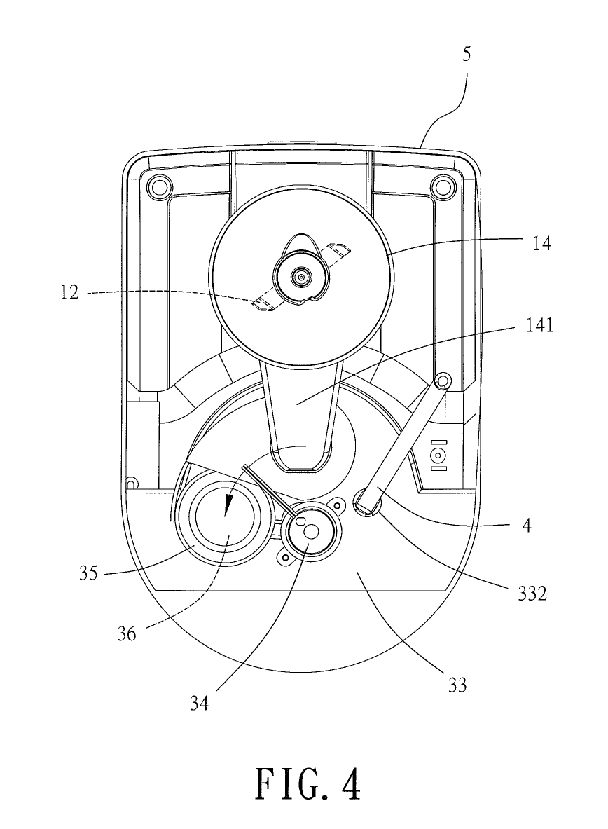

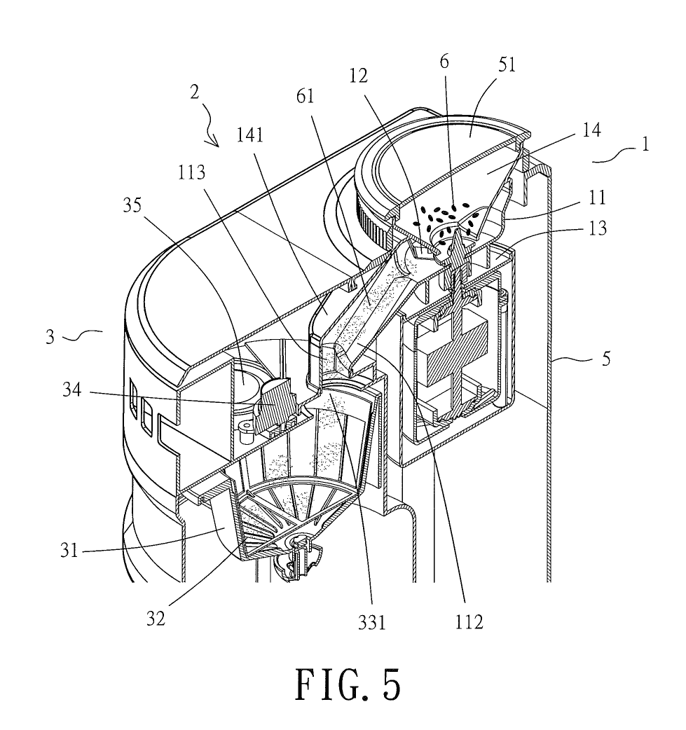

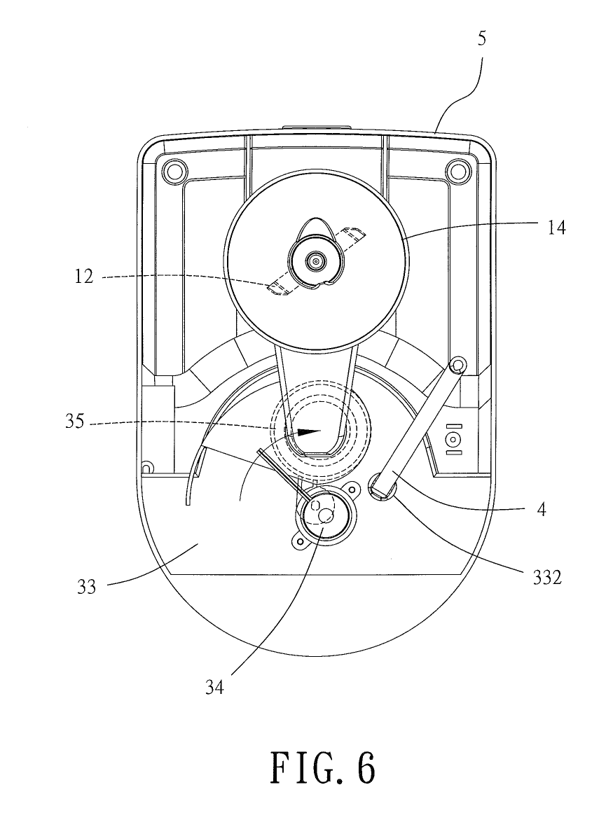

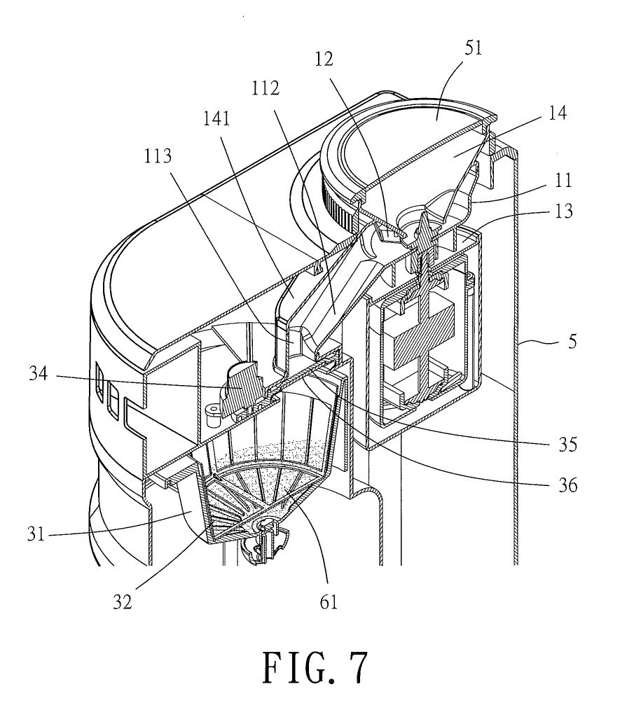

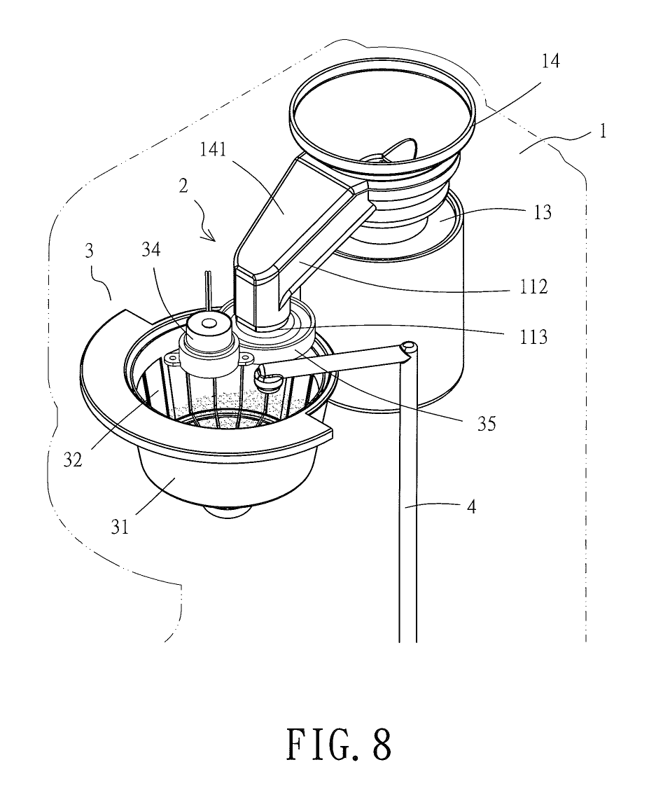

A mechanism for stopping returning steam is disposed in the coffee maker 5 and adapted to operate in conjunction with the coffee bean grinding and brewing process performed by the coffee maker 5 (as shown in FIGS. 2, 4) in the steps described hereunder. In step 1, a user lifts a lid 51 disposed at the top of the coffee maker 5 and places coffee beans 6 in the coffee maker 5 (as shown in FIG. 5), and then the user starts the decelerating motor 34 disposed at the top of the brewing unit 3 so that the decelerating motor 34 drives the lid 35 to open by moving away from the opening 331 of the cover portion 33. In step 2, the driving motor 13 disposed in the coffee maker 5 starts and drives the blade 12 pivotally coupled to the grinding unit 1 from within to grind quickly the coffee beans 6 introduced into the container 11 into coffee particles 61, and then airflow generated as a result of rapid rotation of the blade 12 drives the coffee particles 61 to enter the brewing unit 3 via the conduit 112 extending laterally from the container 11. In step 3, once the quantity of the coffee particles 61 introduced into the filtering chamber 32 of the brewing unit 3 reaches a preset level, the decelerating motor 34 disposed at the top of the brewing unit 3 will drive the lid 35 to undergo a displacement (in the direction of the arrow shown in FIG. 6; see FIG. 7) and shut the opening 331 at the top of the brewing unit 3. In step 4, high-temperature steam is admitted to an inlet 332 at the cover portion 33 at the top of the brewing unit 3 via a conduit 4 (as shown in FIGS. 7, 8) so as to steam the coffee particles 61 in the brewing unit 3. During the brewing process performed on the coffee particles 61 in the brewing unit 3 by means of high-temperature steam, the opening 331 of the cover portion 33 is shut by the lid 35 and the silicone plug 36 thereunder (as shown in FIG. 7), such that the high-temperature steam introduced into the brewing unit 3 is prevented from entering the grinding unit 1 via the conduit 112 to wet the residual coffee particles 61 or coffee beans 6 in the grinding unit 1. The silicone plug 36 is effective in shutting the opening 331 of the cover portion 33 tightly, because the silicone plug 36 undergoes thermal expansion when confronted with the high-temperature steam introduced and thereby operates in conjunction with the lid 35 in providing better hermetic seal.

What is claimed is:

1. A coffee maker capable of stopping returning steam, comprising:
a grinding unit for grinding coffee beans into coffee particles, a guiding unit for discharging the coffee particles; and
a brewing unit for brewing coffee from the coffee particles delivered thereto at high temperature,
wherein a conduit extends laterally from a container disposed at a lower portion of the grinding unit and adapted to hold the coffee particles, and the conduit has an outlet corresponding in position to an opening formed at a preset position of a cover portion at a top of the brewing unit,
wherein a decelerating motor is disposed at a preset position of the cover portion at the top of the brewing unit, and an axle of the decelerating motor is coupled to a lid,
wherein, when the coffee particles exit the grinding unit and enter the brewing unit via the conduit to accumulate in the brewing unit to a preset quantity level, the decelerating motor drives the lid to undergo a displacement and thereby shut the opening at the top of the brewing unit, such that high-temperature steam introduced into the brewing unit for brewing coffee from the coffee particles is prevented from entering the grinding unit via the conduit to wet the residual coffee particles in the grinding unit.

2. The coffee maker capable of stopping returning steam of claim 1, wherein a silicone plug is tightly embedded in a bottom of the lid coupled to the axle of the decelerating motor disposed at the cover portion at the top of the brewing unit, and the silicone plug is effective in shutting the opening of the cover portion tightly, because the silicone plug undergoes thermal expansion when confronted with the high-temperature steam introduced into the brewing unit for making coffee from the coffee particles and thereby operates in conjunction with the lid in providing better hermetic seal.
